(19) United States
(12) Patent Application Publication
(10) Pub. No.: US 2011/0081061 A1
(43) Pub. Date: Apr. 7, 2011

(54) MEDICAL IMAGE ANALYSIS SYSTEM FOR ANATOMICAL IMAGES SUBJECT TO DEFORMATION AND RELATED METHODS

(75) Inventors: David M. Bell, Palm Bay, FL (US); Lauren S. Burrell, West Melbourne, FL (US); Jeremy D. Jackson, Melbourne, FL (US); Timothy R. Culp, Viera, FL (US)

(73) Assignee: Harris Corporation, Melbourne, FL (US)

(21) Appl. No.: 12/572,571

(22) Filed: Oct. 2, 2009

(51) Int. Cl. G06K 9/00

(52) U.S. Cl. 382/130

(57) ABSTRACT

A medical image analysis system is for first and second anatomical image data of a same body area and subject to deformation. The first and second anatomical image data includes respective first and second sets of voxels. The medical image analysis system includes a processor cooperating with a memory to generate a respective reach array for each voxel of the second anatomical image data, with each reach array being a subset of contiguous voxels. The processor also generates a cost array for each reach array, with each cost array based upon probabilities of voxels of the reach array matching voxels of the first anatomical image data. The processor may also solve each cost array using belief propagation to thereby generate a deformation vector array between the first and second anatomical image data.

### FIELD OF THE INVENTION

The present invention relates to the field of image analysis, and, more particularly, to a medical image analysis system and related methods.

### BACKGROUND OF THE INVENTION

Medical imaging technologies provide medical practitioners detailed information useful for differentiating, diagnosing, or monitoring the condition, structure, and/or extent of various types of tissue within a patient's body. In general, medical imaging technologies detect and record manners in which tissues respond in the presence of applied signals and/or injected or ingested substances, and generate visual representations indicative of such responses.

A variety of medical imaging technologies exist, including Computed Tomography (CT), Positron Emission Tomography (PET), Single Photon Emission Computed Tomography (SPECT), and Magnetic Resonance Imaging (MRI). Various medical imaging technologies are suitable for differentiating between specific types of tissues. A contrast agent is typically administered to the patient to enhance or affect the imaging properties of particular tissue types to facilitate improved tissue differentiation. For example, MRI may excel at distinguishing between various types of soft tissue, such as malignant and/or benign breast tumors or lesions that are contrast enhanced relative to healthy breast tissue in the presence of a contrast agent.

Particular imaging techniques, such as certain MRI techniques, may scan a volume of tissue within an anatomical region of interest. Scan data corresponding to an anatomical volume under consideration may be transformed into or reconstructed as a series of planar images or image “slices.” For example, data generated during a breast MRI scan may be reconstructed as a set of 40 or more individual image slices. A given image slice comprises an array of volume elements or voxels.

Medical imaging techniques may generate or obtain imaging data corresponding to a given anatomical region at different times or sequentially through time to facilitate detection of changes within the anatomical region from one scan series to another. Medical practitioners often find it helpful to correlate a tissue, organ, or biological structure in one anatomical image to a corresponding tissue, organ, or biological in another anatomical image.

However, living bodies are not rigid and are subject to deformation. For example, if a patient moves even slightly during or between image acquisition procedures, the shape and/or size of a given tissue, organ, or biological structure may change, making it difficult to correlate the given tissue, organ, or biological structure between two anatomical images. Moreover, the shape and/or size of the given tissue, organ, or biological structure may change over time (for example, a tumor may grow or shrink). In addition, the location of the given tissue, organ, or biological structure may be different relative to its surroundings, in different anatomical images, due to patient movement.

This creates an issue when administering radiation treatment to cancer patients. A radiation treatment plan is typically devised based upon a first anatomical image, yet is administered based upon a second anatomical image taken at a later point in time (typically when the patient is positioned on a table prior to therapy). Due to deformation, it may be difficult for a medical practitioner to accurately aim the radiation at the tumor.

To reduce the effects of deformation of a body upon imaging accuracy, medical imaging techniques that include correction procedures known as registration procedures have been developed. Some registration procedures compare landmarks of a pair of anatomical images. For example, U.S. Pat. Pub. 2007/0179377 to Carlsen et al. discloses a method of image registration that includes selecting landmarks in first and second anatomical images and comparing the similarity thereof. A deformation field, representing deformation of the first anatomical image with respect to the second anatomical image is generated based upon the similarity of the first and second anatomical images. The deformation field is used to register the first and second anatomical images.

Other registration methods involve the determination of mutual histogram values between two anatomical images. Such a method is disclosed in U.S. Pat. No. 7,280,710 to Castro-Pareja et al., which discloses the determination of mutual histogram values between first and second anatomical images. Mutual information between the first and second anatomical images is determined based upon the mutual histogram values. The first and second anatomical images are then registered based upon the mutual information.

Yet other registration methods include the estimation of transformations between first and second anatomical images. For example, U.S. Pat. No. 6,611,615 to Christensen discloses an image registration method including the estimation of a consistent forward transformation and a consistent reverse transformation between the first and second anatomical images by minimizing a difference between a current forward transformation and the inverse of a current reverse transformation, and by minimizing a difference between a current reverse transformation and an inverse of a current forward transformation. The first and second anatomical images are then registered based upon the consistent forward transformation and the consistent reverse transformation.

Registration procedures such as those discussed may be helpful for comparing different anatomical images. Indeed, U.S. Pat. No. 4,987,412 to Vaitekunas et al. discloses such an application. Vaitekunas et al. discloses the displaying of multiple anatomical images of a same body on one or more monitors of a graphics system. Landmarks are located in each image, and mapping functions from one image to another are calculated based upon the landmark locations. A location selected by positioning a cursor on a first image is mapped to a second image and location identifiers are simultaneously displayed in those images. Movement of the cursor on the first image causes simulations movement of the location identifiers on the second image to a position corresponding to the location of the cursor on the first image.

Additional advances in the development of registration procedures that deliver greater accuracy and/or greater speed may still be desired, however.

### SUMMARY OF THE INVENTION

In view of the foregoing background, it is therefore an object of the present invention to provide a medical image analysis system that compares first and second anatomical image data and accurately determines the deformation therebetween.

This and other objects, features, and advantages in accordance with the present invention are provided by a medical image analysis system for first and second anatomical image data of a same body area and subject to deformation, with the first and second anatomical image data comprising respective first and second sets of voxels. The medical image analysis system may comprise a memory and a processor cooperating with the memory. The processor may be configured to generate a respective reach array for each voxel of the second anatomical image data, with each reach array comprising a subset of contiguous voxels. The processor may be further configured to generate a cost array for each reach array, with each cost array based upon probabilities of voxels of the reach array matching voxels of the first anatomical image data. In addition, the processor may also be configured to solve each cost array using belief propagation to thereby generate a deformation vector array between the first and second anatomical image data.

The processor may also be configured to register the first and second anatomical image data based upon the deformation vector array to thereby generate composite anatomical image data. Registration of the first and second anatomical images advantageously allows a medical practitioner, upon review of the anatomical images, to correlate a portion of the first anatomical image (for example, a patient's liver) to a respective similar portion of the second anatomical image. This is particularly helpful because organs and other internal anatomic structures deform and move as a patient moves and therefore may not be in a same position on both the first and second anatomical images.

In addition, the processor may also be configured to determine changes between the first and second anatomical image data as part of the composite anatomical image data. A display may be coupled to the processor and wherein the processor may also be configured to generate a composite image on the display based upon the composite anatomical image data. This may advantageously allow a medical practitioner to review the progress of a treatment, such as radiation therapy.

The first anatomical image data may include a target treatment area therein and the processor may be further configured to map the target treatment area into the second anatomical image data based upon the deformation vector array. This may be particularly advantageous when administering radiation therapy to a patient, since the treatment plan will typically be devised based upon a first anatomical image, but then actually be administered based upon a second anatomical image taken at a later point in time, such as when the patient is actually laying on a treatment table. Since the human body is not rigid, and therefore subject to deformation, mapping the target treatment area onto the second anatomical image data allows a medical practitioner to ensure that radiation is delivered to the desired portions of the body.

The first and second anatomical image data may have different resolutions in any axis and the processor may be further configured to resample at least one of the first and second anatomical image data to a common resolution. This is helpful because, in radiation therapy for example, the first and second anatomical image data are taken at separate times by different medical imaging scanners with different resolutions. The first anatomical image data is typically obtained prior to the development of a treatment plan and using a high resolution medical scanner. Yet, the second anatomical image data is taken when the patient is on a table, ready to receive radiation therapy, and using a lower resolution medical scanner. Resampling these anatomical images to a common resolution advantageously allows the deformation vector array to be accurately calculated.

An initial reach array may be a fixed reach array and each subsequent reach array may be a variable reach array. Each reach array may be a three-dimensional array of three-dimensional array descriptors. In addition, each cost array may be a three-dimensional array of three-dimensional sub-arrays of scalar cost values.

The processor may be further configured to solve each cost area by at least generating N belief messages for each cost message, with each belief message being based upon another cost message and N-1 or less belief messages associated therewith. Each cost message may then be added with the N belief messages associated therewith to generate a cost-belief sum. A vector of the deformation array may then be formed based upon a smallest cost-belief sum of each cost array.

A method aspect is directed to a method of operating a medical image analysis system for first and second anatomical image data of a same body area and subject to deformation therebetween, with the first and second anatomical image data comprising respective first and second sets of voxels. The method may comprise generating a respective reach array for each voxel of the second anatomical image data, with each reach array comprising a subset of contiguous voxels, using a processor. The method may further include generating a cost array for each reach array, with each cost array based upon probabilities of voxels of the reach array matching voxels of the first anatomical image data, using the processor. The method may also include solving each cost array using belief propagation to thereby generate a deformation vector array between the first and second anatomical image data, using the processor.

### BRIEF DESCRIPTION OF THE DRAWINGS

FIG. 1 is a block diagram of a medical image analysis system in accordance with the present invention.

FIG. 2 is a flowchart of a method of operating the medical image analysis system of FIG. 1.

FIG. 3 is a flowchart detailing the belief propagation shown in FIG. 2.

FIG. 4A is a first anatomical image in accordance with the present invention.

FIG. 4B is a second anatomical image in accordance with the present invention.

FIG. 4C is an overlay of the first and second anatomical images in accordance with the present invention.

FIG. 4D is a registered composite image of the first and second anatomical images in accordance with the present invention.

FIG. 5 is a block diagram of another embodiment of a medical image analysis system in accordance with the present invention.

FIG. 6 is a flowchart of a method of operating the medical image analysis system of FIG. 5.

FIG. 7 is a flowchart detailing generation of the deformation vector array of FIG. 6.

FIG. 8A is a first anatomical image with a first cursor thereon in accordance with the present invention.

FIG. 8B is a second anatomical image with a second cursor thereon in accordance with the present invention.

FIG. 9 is a block diagram of a further embodiment of a medical image analysis system in accordance with the present invention.

FIG. 10 is a flowchart of a method of operating the medical image analysis system of FIG. 9.

FIG. 11A is a schematic diagram of a cost array in accordance with the present invention.

FIG. 11B is a schematic diagram of twenty-six-way belief propagation in accordance with the present invention.

FIG. 11C is a schematic diagram of six-way belief propagation in accordance with the present invention.

FIG. 11D is a schematic diagram of eighteen-way belief propagation in accordance with the present invention.

FIG. 11E is a schematic diagram of fourteen-way belief propagation in accordance with the present invention.

FIG. 12A is a schematic diagram of a cost array with a horizontal edge therein in accordance with the present invention.

FIG. 12B is a schematic diagram of a cost array with a planar diagonal edge therein in accordance with the present invention.

FIG. 12C is a schematic diagram of a cost array with a non-planar diagonal edge therein in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

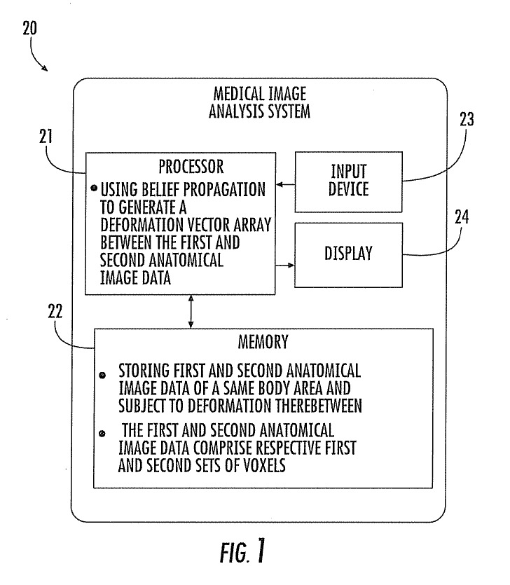

Referring initially to FIG. 1, a medical image analysis system 20 is now described. The medical image analysis system 20 includes a processor 21. A memory 22, an input device 23, and a display 24 are coupled to the processor. The processor 21, memory 22, and display 24 may be any suitable devices known to those of skill in the art. The input device 23 may be a keyboard, mouse, or trackball, for example.

The memory 22 stores first and second anatomical image data of a same body area that comprise respective first and second sets of voxels. For example, the first and second anatomical image data may be of a portion of a lung or liver of a same body. It should be noted that the first and second anatomical image data need not be of the same body, rather just the same body area. Therefore, each may be anatomical image data of a lung of a different patient, such as using one as an atlas, for example.

Since bodies are not rigid, they are subject to deformation. When a body moves, the shape and/or size of a given tissue, organ, or biological structure may change. In addition, the location of the given tissue, organ, or biological structure may change relative to its surroundings as the body moves. Therefore, portions of two anatomical images taken within minutes of each other may not directly correlate. As such, the first and second anatomical image data stored by the memory 22 are subject to deformation therebetween.

A goal of the medical image analysis system 20 is to “register” the first and second anatomical images. That is, to correlate respective portions of the first and second anatomical images to each other. This is particularly advantageous because it will allow a medical practitioner to correlate a tissue, organ, or biological structure in the first anatomical image data to a corresponding tissue, organ, or biological in the second anatomical image data. With registration, a medical practitioner can more accurately deliver radiation to a desired treatment area, or can monitor the growth or shrinkage of a tumor, for example.

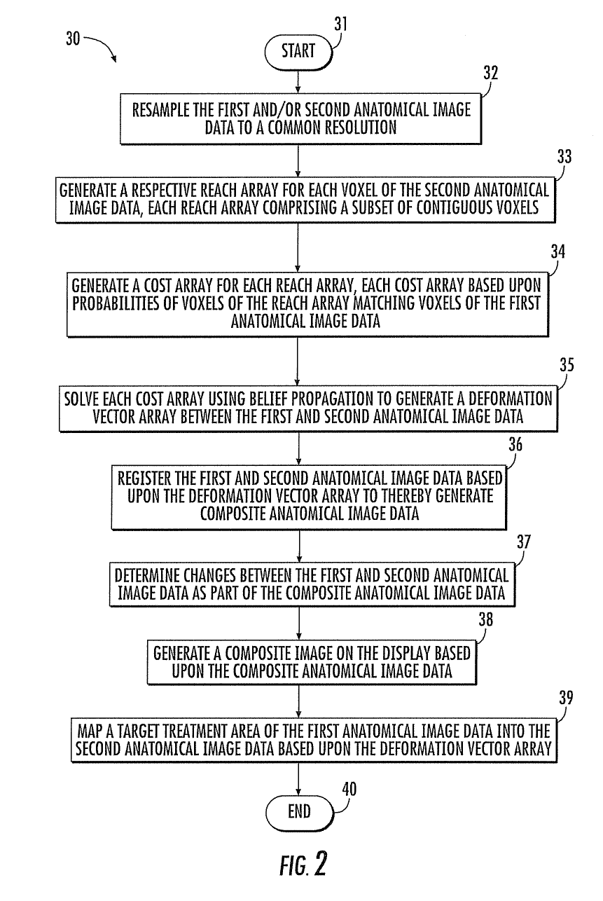

Operation of the medical image analysis system 20 is now described with additional reference to the flowchart 30 of FIG. 2. After the start (Block 31), the first and second anatomical image data are optionally resampled to a common resolution (Block 32). This step is typically performed when the first and second anatomical image data have different resolutions. This typically occurs when the first and second anatomical image data are taken at different points in time by different machines. For example, in radiation therapy, first anatomical image data is typically obtained via a high resolution CT scan and a treatment plan is developed based upon that first anatomical image data. When the radiation therapy is actually to be administered to the patient, the second anatomical image data is obtained via a lower resolution scan as the patient is on a treatment table.

Next, a respective reach array is generated by the processor, each reach array comprising a subset of contiguous voxels (Block 33). Each reach array is a three-dimensional array of three-dimensional array descriptors (voxels). Generation of reach arrays is known to those of skill in the art, however, generally speaking, each reach array is a subset of voxels of the second anatomical image data in which a likely match or correlation for a given voxel of the first anatomical image data resides.

More particularly, a respective reach array is generated by the processor for the set of cost measurements to be made between the first anatomical image and the second anatomical image. The cost measurements are performed over a regular grid of voxel locations in the first anatomical image, with equal spacing between the grid locations. The locations may be constrained to a region of interest within the image. For each voxel location in the first anatomical image, the cost measurement will be computed over a range of voxel locations in the second anatomical image. This range of voxel locations is also a regular grid of voxel locations in the second anatomical image with equal spacing between the grid locations. The extent of this range of voxel locations in the second image is chosen to be larger than the expected deformation between the first and second anatomical image. The spacing of grid locations of this range determines the spatial resolution of the set of cost measurements.

Each reach array may be a three-dimensional array of three-dimensional array descriptors, which describe the location of cost measurements to be performed in the first anatomical image, and for each location a description of the 3D range of voxel locations in the second anatomical image.

In some applications, the registration is performed with multiple steps. The initial step provides an approximate solution, and the remaining steps provide increasingly refined solutions. Each step includes belief propagation, as described below. The initial step has an initial reach array that is a fixed reach array and each subsequent step has a reach array that is a variable reach array. In the initial step, the range of expected deformations is the same for each cost measurement location in the first anatomical image.

In the remaining steps, the deformation solution, obtained by the prior step, reduces the range of expected deformations. The reduction in expected deformation may not be the same for every cost measurement location in the first anatomical image. In regions where the deformation is changing rapidly, the range of expected deformation is larger than it would be in regions where the prior deformation solution is not changing rapidly. The variable reach array used by the steps after the initial step, permits a reduction in the total number of cost measurements to be made, and therefore a reduction in the computation time.

A cost array is generated by the processor for each reach array (Block 34). Each cost array is a three-dimensional array of three-dimensional sub-arrays of scalar cost values.

Although the generation of cost arrays is known to those of skill in the art, in general terms, each cost array is based upon probabilities of voxels of the reach array matching voxels of the first anatomical image data.

In particular, each reach array contains a three-dimensional array of three-dimensional array descriptors, which describe the location of cost measurements to be performed in the first anatomical image, and for each location, a description of the 3D range of voxel locations in the second anatomical image. Each cost array is a three dimensional array of three dimensional sub-arrays of scalar cost values. Each scalar cost value is calculated at a measurement location in the first anatomical image and another location in the second anatomical image, as described in the reach array. Each scalar cost value is calculated using a neighborhood of voxels surrounding the measurement locations in both the first and second anatomical image. The neighborhood is usually described as a three dimensional window of a specified size, for example 7×7×7.

Although the generation of cost values is known to those of skill in the art, in general terms, each cost value is based upon the probabilities of voxels in the neighborhood of the measurement location in the first anatomical image matching voxels in the neighborhood of the measurement location in the second anatomical image. The processor may use different cost calculation methods. One such method is the normalized cross correlation method. Another such method is the sum of absolute differences of the voxel values. The choice of which method to use is selectable and may be determined by the characteristics of the two anatomical images. For example, the sum of absolute differences method could be used for matching two CT images, the normalized cross correlation method may be used to match an MRI image to a CT image.

Each cost array is then solved by the processor, using belief propagation, to generate a three dimensional array of three dimensional deformation vectors (a deformation vector array) between the first and second anatomical image data (Block 35). Belief propagation, sometimes called loopy belief propagation, is a particularly helpful analysis technique known to those skilled in the art. For example, belief propagation is used in some stereo analysis algorithms for pairwise two dimensional images, such as may be found in a paper titled Effective Belief Propagation for Early Vision, by Felzenszwalb and Huttenlocher, the contents of which are hereby incorporated by reference in their entirety.

The vectors of the deformation vector array represent the direction and magnitude of distortion of one portion of the first anatomical image data with respect to a corresponding portion of the second anatomical image data, or vice versa. As will be described below, the deformation vector array enables many useful image analysis applications.

The first and second anatomical image data are then illustratively registered, by the processor, based upon the deformation vector array to generate composite anatomical image data (Block 36). Changes between the first and second anatomical image data may be determined, by the processor, and indicated or highlighted as part of the composite anatomical image data (Block 37).

The composite image may be generated on the display based upon the composite anatomical image data (Block 38). This may allow a medical practitioner to monitor changes to a tumor or organ, for example.

A target treatment area of the first anatomical image may be designated, and may be mapped by the processor into the second anatomical image data based upon the deformation vector array (Block 39). This functionality is particularly useful for administering radiation therapy to a patient, as the outline of a tumor can be traced in the high resolution first anatomical image data. Then, a corresponding target treatment area can be displayed on the second anatomical image data on the display. Since the second anatomical image data will typically be taken as the patient is laying on a table and ready for radiation treatment, the mapping of the treatment area in to the second anatomical image data allows a medical practitioner to more accurately direct radiation treatment at a desired portion, such as the tumor. Block 40 indicates the end of operation of the medical image analysis system.

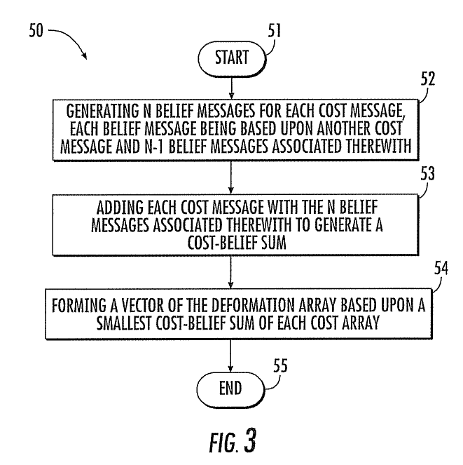

Further details of the belief propagation performed at Block 35 are now described with additional reference to the flowchart 50 of FIG. 3. After the start (Block 51), N belief messages are generated, by the processor, for each cost message (Block 52). Each belief message is based upon another cost message and N-1 belief messages associated therewith. Generally speaking, each belief message represents a belief of one voxel of the second anatomical image data that another voxel thereof correlates to a given voxel of the first anatomical image data.

Each cost message is added, by the processor, with the N belief messages associated therewith to generate a cost-belief sum (Block 53). A vector of the deformation array is formed based upon a smallest cost-belief sum of each cost array (Block 54). Blocks 52, 53, and 54 are repeated for each cost array. Block 55 indicates the end of the belief propagation.

More specifically, belief propagation is a special case of the sum-product algorithm and is a message passing algorithm for performing inference on graphical models. It is an inherently Bayesian procedure, which calculates the marginal distribution for each unobserved node, conditional on any observed nodes. If X=(Xv) is a set of discrete random variables with a joint mass function p, the marginal distribution of a single Xi is simply the summation of p over the other variables is:

$${p}_{{X}_{i}} ( {x}_{i} ) = {\sum }_{{x}^{′} : {x}_{i}^{′} = {x}_{i}} p ( {x}^{′} ) .$$

However this quickly becomes computationally prohibitive: if there are 100 binary variables, then one needs to sum over 299≈6.338×10²⁹ possible values. By exploiting a graphical structure, belief propagation allows the marginals to be computed much more efficiently.

Belief propagation operates on a factor graph: a bipartite graph containing nodes corresponding to variables V and factors U, with edges between variables and the factors in which they appear. The joint mass function can be written as:

$$p ( x ) = {\prod }_{u ∈ U} {f}_{u} ( {x}_{u} )$$

where xᵤ is the vector of neighboring variable nodes to the factor node u. Any Bayesian network or. Markov random field can be represented as a factor graph.

The belief propagation works by passing real valued functions called belief messages along the edges between the nodes. These contain the “influence” that one variable exerts on another. There are two types of messages:

A message from a variable node v to a factor node u is the product of the messages from the other neighboring factor nodes:

$${μ}_{v \to u} ( {x}_{u} ) = {\prod }_{{u}^{*} ∈ N ( v ) \backslash \{ u \}}^{ } {μ}_{{u}^{*} \to υ} ( {x}_{v} ) .$$

where N(v) is the set of neighboring (factor) nodes to v.

A message from a factor node u to a variable node v is the product of the factor with messages from the other nodes, marginalized over xᵥ:

$${μ}_{u \to v} ( {x}_{v} ) = {\sum }_{{x}_{u}^{′} : {x}_{v}^{′} = {x}_{v}} {f}_{u} ( {x}_{u}^{′} ) {\prod }_{{v}^{*} ∈ N ( u ) \backslash \{ v \}}^{ } {μ}_{{v}^{*} \to u} ( {x}_{{v}^{*}}^{′} ) .$$

where N(u) is the set of neighboring (variable) nodes to u.

Further details of belief propagation may be found in a paper titled Effective Belief Propagation for Early Vision, by Felzenszwalb and Huttenlocher, the contents of which are hereby incorporated in reference in their entirety.

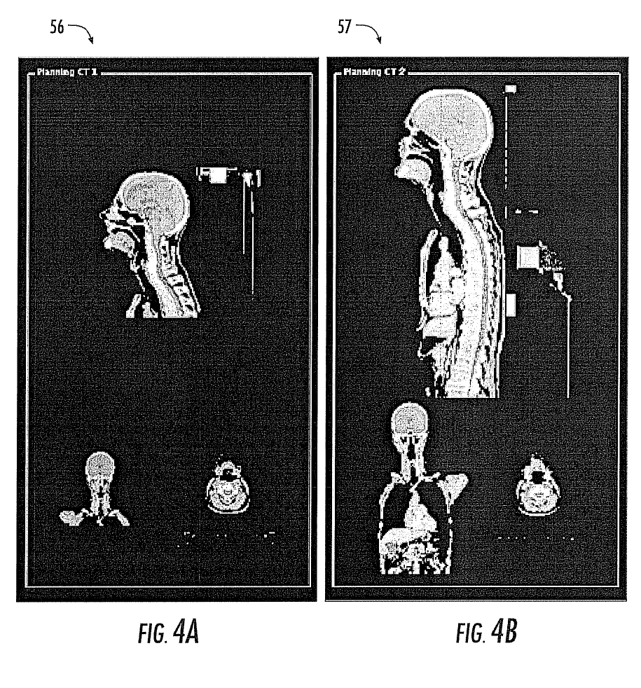

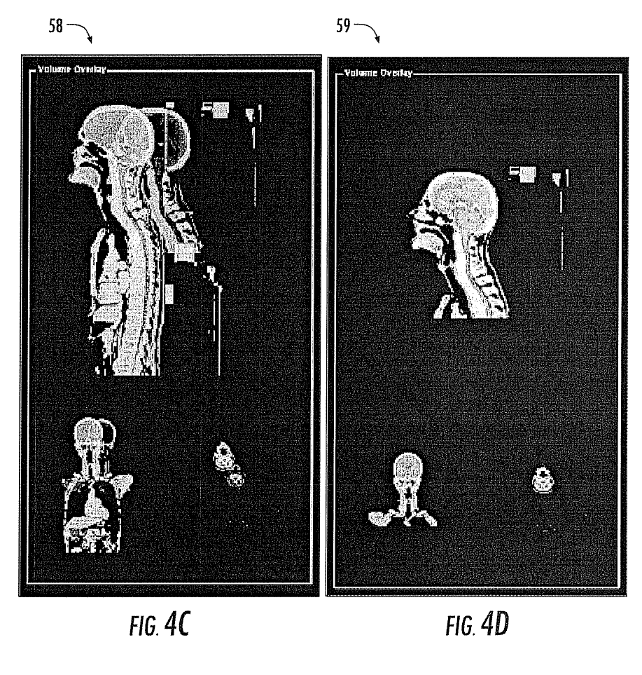

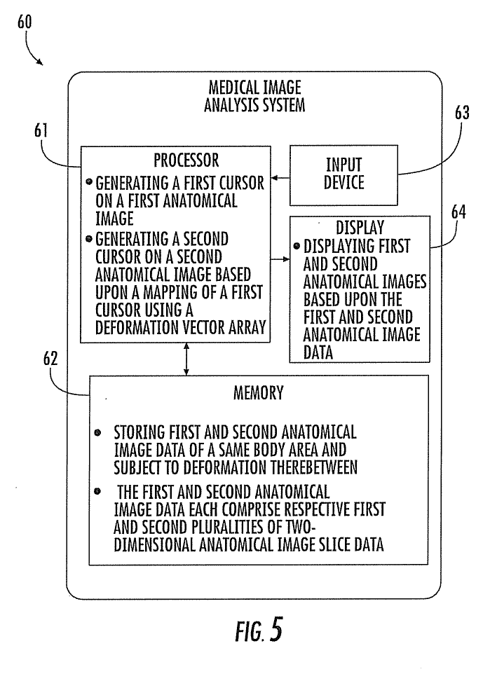

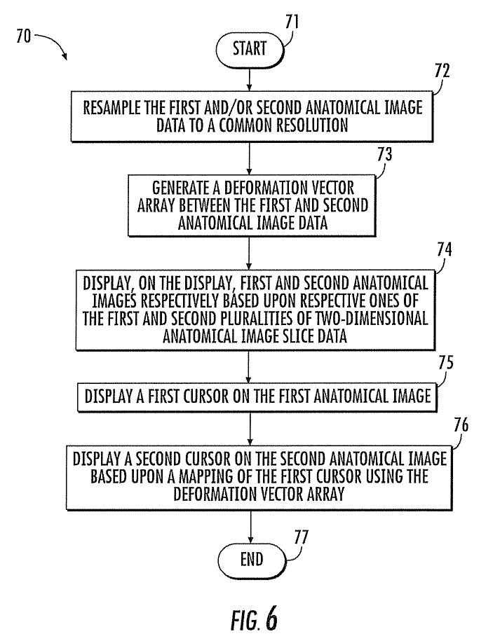

Examples of first and second anatomical images based upon the first and second anatomical image data are shown in FIGS. 4A and 4B. As seen, the patient's neck is at a different angle in the first anatomical image 56 than it is in the second anatomical image 57. A direct overlay of these two images 58 has numerous mismatches, as shown in FIG. 4C. By registering the first and second anatomical images, a readable composite image 59 can be produced. This composite image can be used by a medical practitioner to quickly determine changes between the first anatomical image 56 and the second anatomical image 57.

One particularly advantageous application of the deformation vector array is now described with reference to the embodiment of a medical image analysis system 60 shown in FIG. 5. Here, the medical image analysis system 60 comprises a processor 61. A memory 62, input device 63, and display 64 are coupled to the processor 61 and may be suitable devices as known to those of skill in the art. The memory 62 stores first and second anatomical image data of a same body area which are subject to deformation therebetween. The first and second anatomical image data comprise first and second pluralities of two-dimensional anatomical image slice data, respectively, as typically provided by a CT scan.

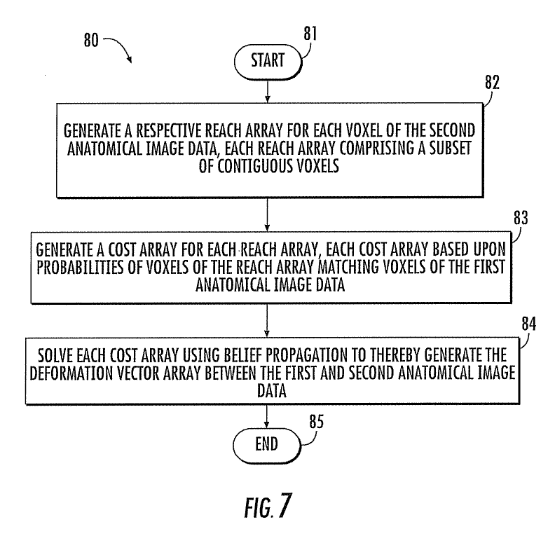

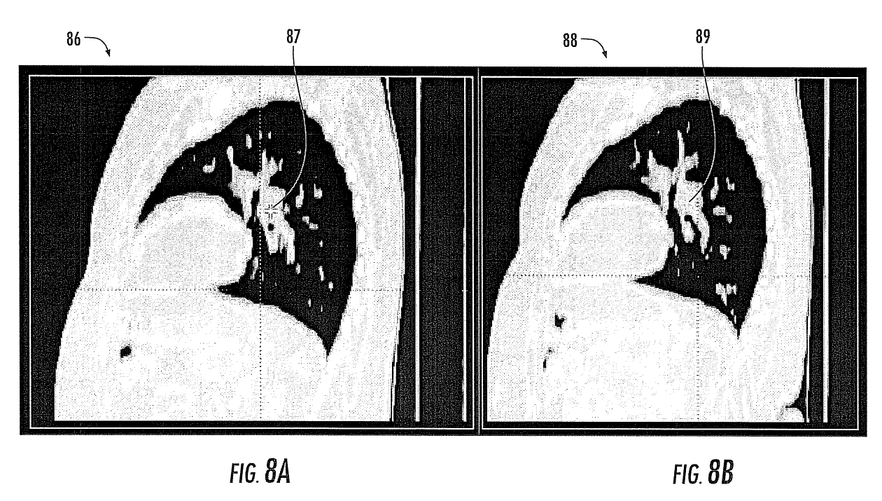

Operation of this medical image analysis system 60 is now described with reference to flowchart 70 of FIG. 6. After the start (Block 71), the first and/or second anatomical image data may be resampled to a common resolution (Block 72). A deformation vector array between the first and second anatomical image data is then generated (Block 73). The resampling and generation of the deformation vector array may be performed as described above with reference to the medical image analysis system 20.

First and second anatomical images, based upon the first and second pluralities of two-dimensional anatomical image slice data, are displayed on the display (Block 74). A first cursor is displayed on an image slice of the first plurality of two-dimensional anatomical image slice data (Block 75). The first cursor is controlled by the input device, such that a medical practitioner may place the first cursor over an area of interest. It should be appreciated that different image slices of the first plurality of two-dimensional anatomical image slice data may be selected for viewing via the input device as well. Indeed, the first plurality of two-dimensional anatomical image slice may typically include many such image slices.

A second cursor is then displayed on the second anatomical image based upon a mapping of the first cursor using the deformation vector array (Block 76). That is, as the first cursor is moved across the first anatomical image, the second cursor tracks it and is moved to corresponding portions of the second anatomical image.

This allows a medical practitioner to easily and quickly correlate a point or area of interest of the first anatomical image to a corresponding area of the second anatomical image. It should be understood that, as the cursor is moved about the first anatomical image, the second anatomical image displayed may actually change, as different slices of the second plurality of two-dimensional anatomical image slice data may contain the various tissues, organs, and/or anatomical structures shown in the first anatomical image.

Without this medical image analysis system 60, a medical practitioner would simply compare slices of the first and second pluralities of two-dimensional anatomical image slice data and attempt to correlate images visually. This is not only time consuming, but may be inaccurate.

It should also be appreciated that the second cursor may be positioned over an area of interest on the second anatomical image, and a corresponding first cursor will be displayed on the first anatomical image based upon a mapping of the second cursor using the deformation vector array. Thus, as the second cursor is moved across the second anatomical image, the first cursor tracks it and is moved to corresponding portions of the first anatomical image.

Example operation of the medical image analysis system 60 is now further described with reference to FIGS. 8A and 8B. The first anatomical image 86 is shown in FIG. 8A, and the second anatomical image 88 is shown in FIG. 8B. These images are shown as they would be on the display 64. Here, the first cursor 87 is pointing to a point of interest on the first anatomical image 86. The second cursor 89 tracks the first cursor 87 and points to a corresponding portion of the second anatomical image 89, based upon the mapping performed using the deformation vector array. A quick glance reveals that there is deformation between the first anatomical image 86 and the second anatomical image 88, and that a medical practitioner would otherwise have to correlate portions of these images to each other manually without the medical image analysis system 60.

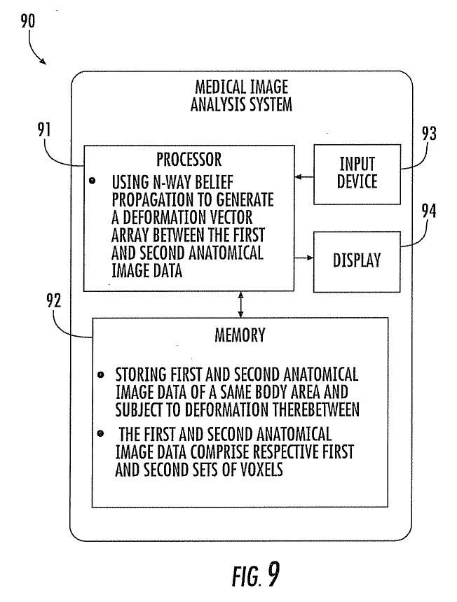

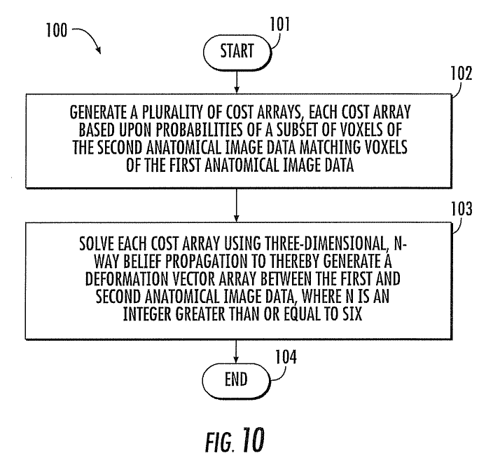

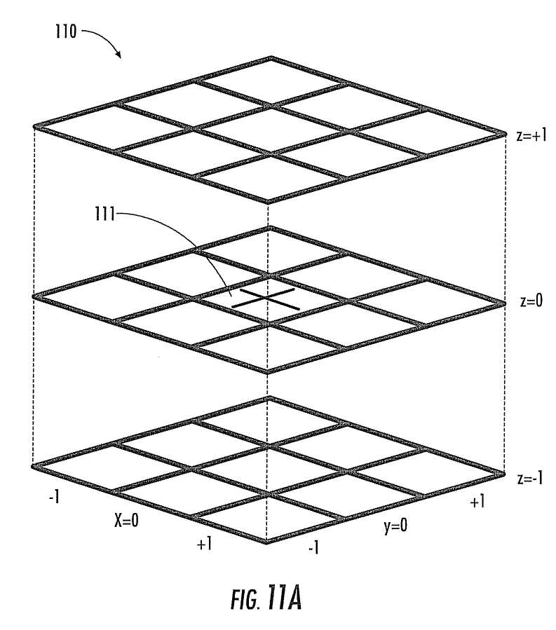

A further embodiment of a medical image analysis system 90 is now described with reference to FIG. 9. The medical image analysis system 90 includes a processor 91. A memory 92, input device 93, and display 94 are coupled to the processor 91. The memory 92 stores first and second anatomical image data of a same body area and subject to deformation. The first and second anatomical image data comprise sets of voxels, as will be appreciated by those of skill in the art.

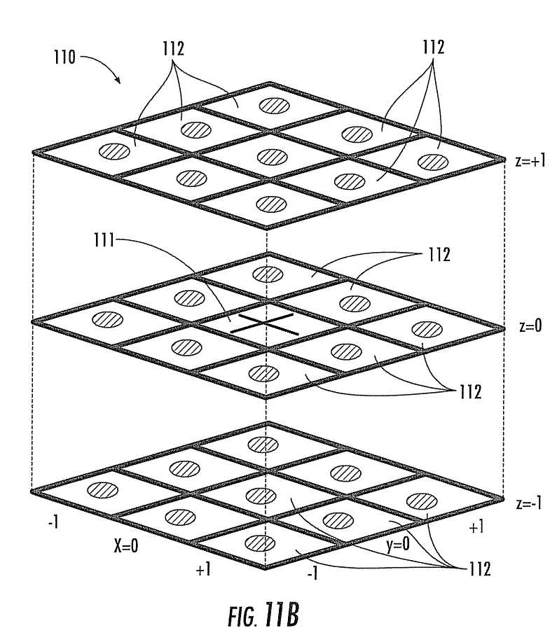

Operation of this system 90 is now described with reference to the flowchart 100 of FIG. 10. After the start (Block 101), a plurality of cost arrays are generated (Block 102). Each cost array is based upon probabilities of a subset of voxels of the second anatomical image data matching voxels of the first anatomical image data. Further details of the generation of the cost arrays may be found above with reference to the medical image analysis system 20.

Each cost array is solved using three-dimensional, N-way belief propagation to thereby generate a deformation vector array between the first and second anatomical image data (Block 103). N is an integer greater than or equal to six.

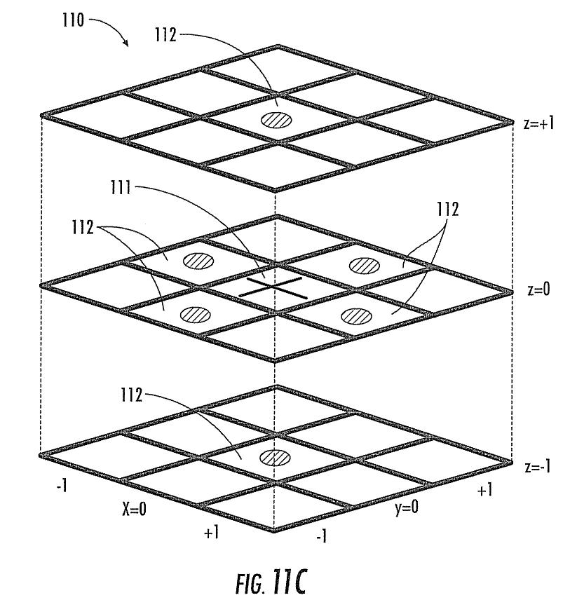

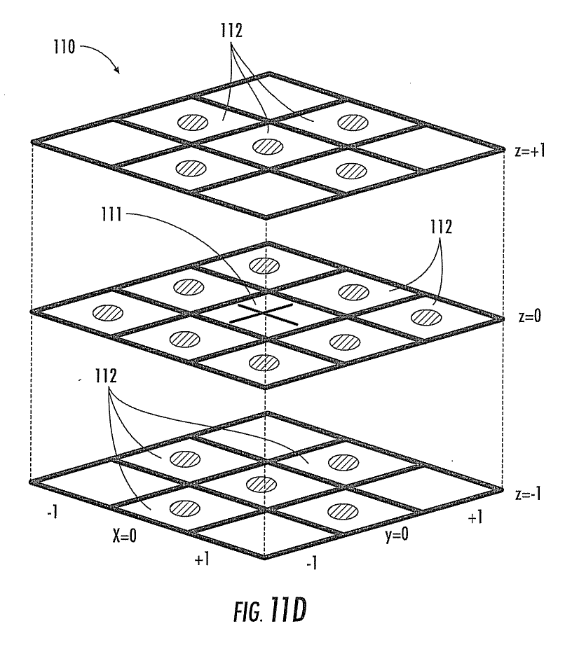

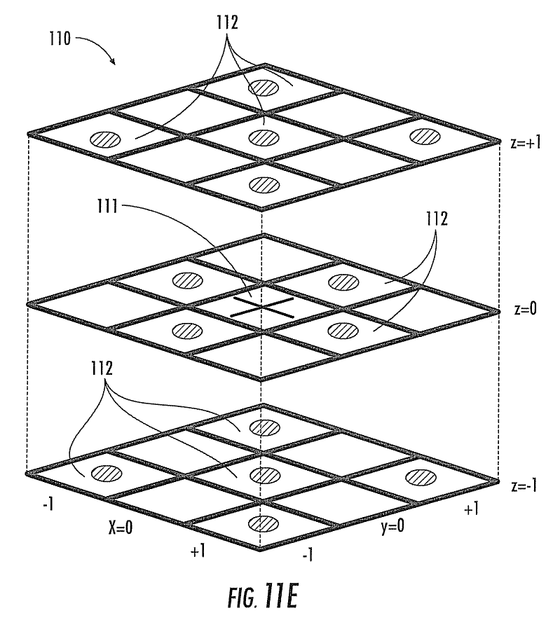

As explained above, each cost array is a three-dimensional array of three-dimensional sub-arrays of scalar cost values. A portion of a cost array 110 is graphically represented in FIG. 11A. Here, a given cost message 111 has twenty-six neighbors since each cost value is an element of a three-dimensional array. The cost array has eight neighbors in the same position on the z-axis (shown as z=0), nine neighbors ‘above’ it (shown as z=+1), and nine neighbors below it (shown as z=−1).

Generally speaking, in belief propagation, each cost value is considered to be a node. Each node sends belief messages to some of its neighboring nodes. The belief messages represent a belief by one node that a voxel of the second anatomical image data upon which a cost value of a node is based upon correlates to a given voxel of the first anatomical image data.

As will be readily apparently to those skilled in the art, the fewer belief messages sent by each node, the less processor resources will be consumed by the belief propagation. However, in determining how many belief messages each node should send (determining N), it may be useful to consider the sensitivity of the belief propagation to “edges.” An edge is, roughly speaking, an abrupt change in the anatomical image data. For example, there may be an area of voxels that differs substantially from surrounding voxels in intensity (color), such as along an organ boundary. In the anatomical image data, an area where the voxels abruptly change in intensity is called an edge. The alignment of such edges in anatomical image data is a desired component of the registration process.

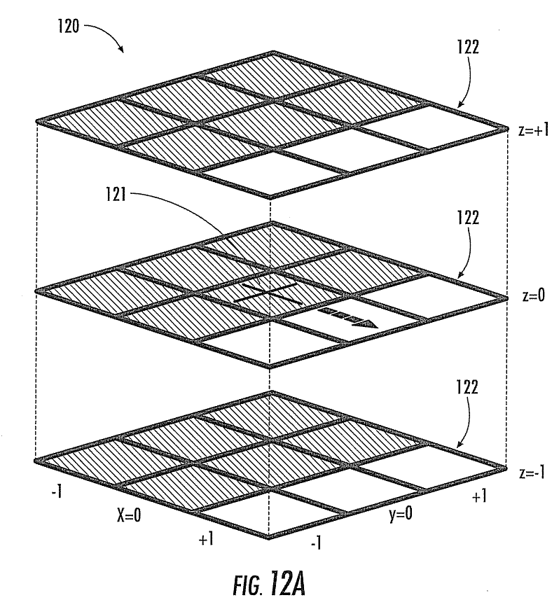

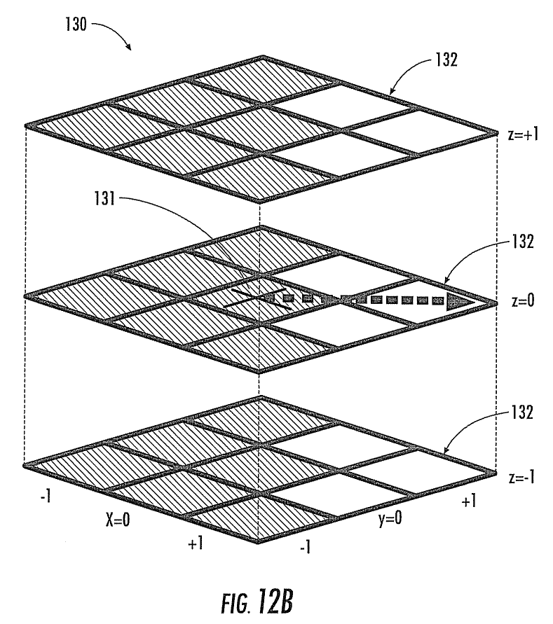

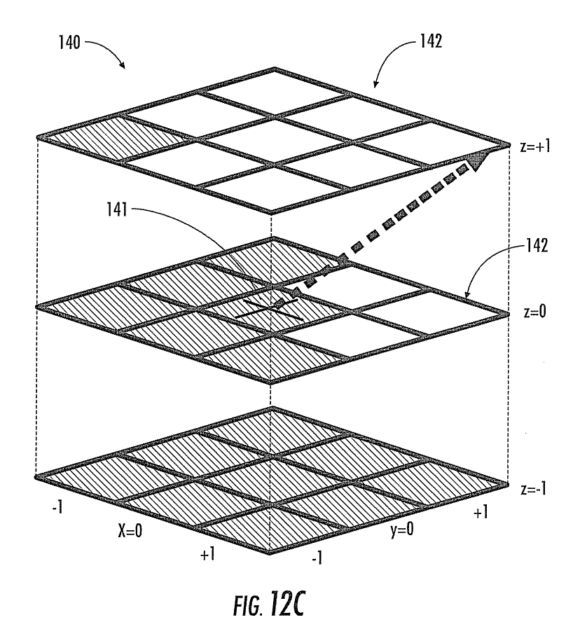

There are three types of edges in the anatomical image data. Shown in the cost array 120 of FIG. 12A is a horizontal edge, where a transition area 122 is horizontally adjacent the cost value or node 121. Another type of edge is a planar diagonal edge, as shown in the cost array 130 of FIG. 12B. Here, the edge is a planar diagonal edge where the transition area 132 is diagonally adjacent cost value or node 131 and in the same plane thereof. The other type of edge is a non-planar diagonal edge, as shown in the cost array 140 of FIG. 12C. Here, the edge is a non-planar diagonal edge where the transition area 142 is diagonally adjacent the cost value or node 141 but not in the same plane thereof.

Existing belief propagation methods include twenty-six-way belief propagation. As shown in FIG. 11B, each cost message 111 sends a belief message to all twenty-six of its neighbors 112. That is, this is twenty-six-way belief propagation (N is twenty-six). However, twenty-six-way belief propagation is very processor intensive. Since it is desirable for the medical image analysis system 90 to compute a solution while the patient is awaiting treatment, such twenty-six-way belief propagation is not desirable.

The other existing belief propagation method is six-way belief propagation (where N is six). As shown in FIG. 11C, each cost message 111 sends a belief message to six of its neighbors. While this six-way belief propagation is quickly performed and far less processor intensive than twenty-six-way belief propagation, it may not be as sensitive to planar and non planar diagonal edges as it is to planar non-diagonal edges. That is, six-way belief propagation may yield inaccurate results in the presence of diagonal edges. As such, six-way belief propagation may not desirable.

One approach that saves processor resources yet yields acceptable results, with sufficient edge sensitivity to diagonal edges, is eighteen-way belief propagation (where N is eighteen). As shown in FIG. 11D, each cost message 111 sends belief messages to eighteen of its neighbors. This eighteen-way belief propagation yields acceptable results in the presence of diagonal edges and consumes less resources than twenty-six-way belief propagation.

Fourteen-way belief propagation (where N is fourteen) is illustrated in FIG. 11E, where each node or cost value 111 sends belief messages to fourteen of its neighbors. Fourteen-way belief propagation has been found to actually have better performance and better overall edge sensitivity than eighteen-way belief propagation, yet consumes less processor resources, for some applications, such as medical image analysis.

The chart below shows comparison of the edge sensitivities and speed of six-way, fourteen-way, eighteen-way, and twenty-six-way belief propagation.

| | Planar Non | Planar | Non-Planar | |
|---|---|---|---|---|
| | Diagonal | Diagonal | Diagonal | |
| | Edge | Edge | Edge | |
| N-Way | Sensitivity | Sensitivity | Sensitivity | Speed |
| 6-way | 83.3% | 66.6% | 50.0% | 26/6 = 4.33 |
| 14-way | 64.3% | 71.4% | 57.1% | 26/14 = 1.86 |
| 18-way | 72.2% | 61.1% | 55.6% | 26/18 = 1.44 |
| 26-way | 69.2% | 69.2% | 57.7% | 26/26 = 1.00 |

As shown in the chart, fourteen-way belief propagation may be considered as striking the best balance of edge sensitivity and speed.

Other details of such medical image analysis systems 20 may be found in co-pending applications MEDICAL IMAGE ANALYSIS SYSTEM FOR DISPLAYING ANATOMICAL IMAGES SUBJECT TO DEFORMATION AND RELATED METHODS, Attorney Docket No. 61722 and MEDICAL IMAGE ANALYSIS SYSTEM USING N-WAY BELIEF PROPAGATION FOR ANATOMICAL IMAGES SUBJECT TO DEFORMATION AND RELATED METHODS, Attorney Docket No. 61723, the entire disclosures of which are hereby incorporated by reference.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A medical image analysis system for first and second anatomical image data of a same body area and subject to deformation, the first and second anatomical image data comprising respective first and second sets of voxels, the medical image analysis system comprising:
a memory; and
a processor cooperating with said memory and configured to
generate a respective reach array for each voxel of the second anatomical image data, each reach array comprising a subset of contiguous voxels,
generate a cost array for each reach array, each cost array based upon probabilities of voxels of the reach array matching voxels of the first anatomical image data, and
solve each cost array using belief propagation to thereby generate a deformation vector array between the first and second anatomical image data.

2. The medical image analysis system of claim 1 wherein said processor is also configured to register the first and second anatomical image data based upon the deformation vector array to thereby generate composite anatomical image data.

3. The medical image analysis system of claim 2 wherein said processor is also configured to determine changes between the first and second anatomical image data as part of the composite anatomical image data.

4. The medical image analysis system of claim 3 further comprising a display coupled to said processor; and wherein said processor is also configured to generate a composite image on said display based upon the composite anatomical image data.

5. The medical image analysis system of claim 1 wherein the first anatomical image data includes a target treatment area therein; and wherein said processor is further configured to map the target treatment area into the second anatomical image data based upon the deformation vector array.

6. The medical image analysis system of claim 1 wherein the first and second anatomical image data have different resolutions; and wherein said processor is further configured to resample at least one of the first and second anatomical image data to a common resolution.

7. The medical image analysis system of claim 1 wherein an initial reach array is a fixed reach array and each subsequent reach array is a variable reach array.

8. The medical image analysis system of claim 1 wherein each reach array is a three-dimensional array of three-dimensional array descriptors.

9. The medical image analysis system of claim 1 wherein each cost array is a three-dimensional array of three-dimensional sub-arrays of scalar cost values.

10. The medical image analysis system of claim 1 said processor is further configured to solve each cost array by at least:
generating N belief messages for each cost message, each belief message being based upon another cost message and N-1 belief messages associated therewith;
adding each cost message with the N belief messages associated therewith to generate a cost-belief sum; and
forming a vector of the deformation array based upon a smallest cost-belief sum of each cost array.

11. A medical image analysis system for first and second anatomical image data of a same body area and subject to deformation, the first and second anatomical image data having different resolutions and comprising respective first and second sets of voxels, the medical image analysis system comprising:
a memory; and
a processor cooperating with said memory and configured to
resample at least one of the first and second anatomical image data to a common resolution,
generate a respective reach array for each voxel of the second anatomical image data, each reach array comprising a subset of contiguous voxels,
generate a cost array for each reach array, each cost array based upon probabilities of voxels of the reach array matching voxels of the first anatomical image data,
solve each cost array using belief propagation to thereby generate a deformation vector array between the first and second anatomical image data, and
register the first and second anatomical image data based upon the deformation vector array to thereby generate composite anatomical image data.

12. The medical image analysis system of claim 11 wherein said processor is also configured to determine changes between the first and second anatomical image data as part of the composite anatomical image data.

13. The medical image analysis system of claim 12 further comprising a display coupled to said processor; and wherein said processor is also configured to generate a composite image on said display based upon the composite anatomical image data.

14. The medical image analysis system of claim 11 wherein the first anatomical image data includes a target treatment area therein; and wherein said processor is further configured to map the target treatment area into the second anatomical image data based upon the deformation vector array.

15. An image analysis system for first and second image data of a same area and subject to deformation, the first and second image data comprising respective first and second sets of voxels, the image analysis system comprising:
a memory; and
a processor cooperating with said memory and configured to
generate a respective reach array for each voxel of the second image data, each reach array comprising a subset of contiguous voxels,
generate a cost array for each reach array, each cost array based upon probabilities of voxels of the reach array matching voxels of the first a image data, and
solve each cost array using belief propagation to thereby generate a deformation vector array between the first and second image data.

16. The image analysis system of claim 15 further comprising a display coupled to said processor;
wherein said processor is also configured to determine changes between the first and second image data as part of the composite image data; and wherein said processor is also configured to generate a composite image on said display based upon the composite image data.

17. The image analysis system of claim 15 wherein the first image data includes a target treatment area therein; and wherein said processor is further configured to map the target treatment area into the second image data based upon the deformation vector array.

18. A method of operating a medical image analysis system for first and second anatomical image data of a same body area and subject to deformation, the first and second anatomical image data comprising respective first and second sets of voxels, the method comprising:
generating a respective reach array for each voxel of the second anatomical image data, each reach array comprising a subset of contiguous voxels, using a processor;
generating a cost array for each reach array, each cost array based upon probabilities of voxels of the reach array matching voxels of the first anatomical image data, using the processor; and
solving each cost array using belief propagation to thereby generate a deformation vector array between the first and second anatomical image data, using the processor.

19. The method of claim 18 further comprising registering the first and second anatomical image data based upon the deformation vector array to thereby generate composite anatomical image data, using the processor.

20. The method of claim 19 further comprising determining changes between the first and second anatomical image data as part of the composite anatomical image data, using the processor.

21. The method of claim 20 further comprising generating a composite image on a display based upon the composite anatomical image data, using the processor.

22. The method of claim 18 wherein the first anatomical image data includes a target treatment area therein; and further comprising mapping the target treatment area into the second anatomical image data based upon the deformation vector array, using the processor.

23. The method of claim 18 wherein the first and second anatomical image data have different resolutions; and further comprising resampling at least one of the first and second anatomical image data to a common resolution.

24. The method of claim 18 wherein an initial reach array is a fixed reach array and each subsequent reach array is a variable reach array.
